(19) United States
(12) Patent Application Publication
(10) Pub. No.: US 2015/0211896 A1
(43) Pub. Date: Jul. 30, 2015

(54) Frequency-Domain Multi-Element Capacitive Proximity Sensor Array Based on a Bandstop Filter Design

(71) Applicant: Mitsubishi Electric Research Laboratories, Inc., Cambridge, MA (US)

(72) Inventors: Bingnan Wang, Belmont, MA (US); Jiang Long, La Jolla, CA (US); Koon Hoo Teo, Lexington, MA (US); Kieran Parsons, Cambridge, MA (US)

(73) Assignee: MITSUBISHI ELECTRIC RESEARCH LABORATORIES, INC., Cambridge, MA (US)

(21) Appl. No.: 14/167,013

(22) Filed: Jan. 29, 2014

(51) Int. Cl. G01D 5/24; G01V 3/00

(52) U.S. Cl. CPC G01D 5/24; G01V 3/00

(57) ABSTRACT

A proximity sensor detects an object. The sensor includes a set of two or more sensing elements. Each sensing elements includes a bandstop filter for selecting a different notch resonant frequency for the element. The notch resonant frequencies are isolated from each other. A change in transmission around each notch frequency is measured detect to the object.

### FIELD OF THE INVENTION

This invention relates to proximity sensors and sensor arrays, and more particularly to frequency-domain capacitive proximity sensors.

### BACKGROUND OF THE INVENTION

A capacitive sensor array can be used in many applications, such as fingerprint sensing, robotic textile sensing, touch screen sensing, proximity sensing, electrical capacitance tomography (ECT), and security scanning, for example. Generally, the capacitive sensor array on an integrated circuit (chip) has N×M elements.

An object can also be sensed from a reflection of a transmission line (TLine), but then signals or data from all the elements are coupled, resulting in large uncertainty.

Multi-resonance has also been used to decouple all the sensing elements. However, the sensing signals are measured with an absorption rate at the resonance.

It is well known that the resonance frequency can be used for measuring capacitance. It is possible to apply multi-resonance into a capacitive sensor array readout, where each resonance corresponds to one sensing element, respectively. Such a multi-resonance method has been used with a split-ring resonator (SRR). With the help of the SRR, the localized electromagnetic field is enhanced to increase the sensitivity. However, this also results in tactile sensing because most of the fields are concentrated on the SRR structure.

U.S. Pat. No. 6,777,244 describes a sensor for detection materials in low concentration. A change in electromagnetic field is detected, and a frequency at which a resonance is observed, is indicative of a particular compound. The detection is based on an oscillation amplitude, which decreases as the materials approach the sensor.

### SUMMARY OF HE INVENTION

The embodiments of the invention provide a frequency-domain multi-element capacitive proximity sensor array based on a bandstop filter design. A multi-element capacitive proximity sensor array is integrated in a multi-bandstop filter. Each bandstop filter is determined by one capacitive sensor respectively. The capacitance can be obtained by measuring a change in transmission around multiple notch frequencies. The multi-element capacitive proximity sensor is designed and fabricated on an epoxy substrate.

The multi-element sensor can form a multi-directional sensor. The elements can also be arranged in a plane and other geometric configurations. Such planar sensors can be used for position sensing, meaning the exact position of an incoming object. One feature of the sensor is the isolation of resonances from each element so that the elements do not interact with each other.

Measurement results show an ability for detecting in multiple directions with a sensing range of about 8 mm.

### BRIEF DESCRIPTION OF THE DRAWINGS

FIG. 1 is a schematic of frequency-domain multi-directional capacitive proximity sensor array according to embodiments of the invention:

FIG. 2A is a schematic of a geometry of a proximity sensor according, to one embodiment of the invention;

FIG. 2B is a schematic of geometries of a proximity sensor according to alternative embodiments the invention;

FIG. 3 is a graph of a capacitance as a function of a distance from an object according to embodiments of the invention;

FIG. 4 is a schematic of how capacitive sensors are integrated into a bandstop filter for a circuit simulation according to embodiments of the invention;

FIG. 5 is a schematic of a sensor with multiple elements arranged along a straight transmission line between an input port (Pin) and output port (Pout) according to embodiments of the invention;

FIG. 6 is a schematic of a sensor with multiple elements arranged along either side of a straight transmission line between an input port (Pin) and output port (Pout) according to embodiments of the invention;

FIG. 7 is a schematic of a sensor with multiple elements arranged along: a circular transmission line between an input port (Pin) and output port (Pout).

### DETAILED DESCRIPTION OF THE PREFERRED EMBODIMENTS

The embodiments of the invention provide a frequency-domain multi-directional capacitive proximity sensor based on a bandstop filter design.

The capacitive sensor uses a change of a capacitive coupling, which can be measured as the capacitance at a driving, point of the sensor. A resonance can be obtained when the capacitance it is connected serially with an inductance. Then, the resonant frequency is dependent on the capacitance value.

Microwave filters use a tuning capacitance for achieving different responses. Particularly, a bandstop filter uses a series parallel-resonance tank and shunt series-resonance tank to form a bandstop response. The shunt series-resonance can be replaced with the capacitive sensor series with an inductor. In this way, the capacitive sensor is integrated into a bandstop filter.

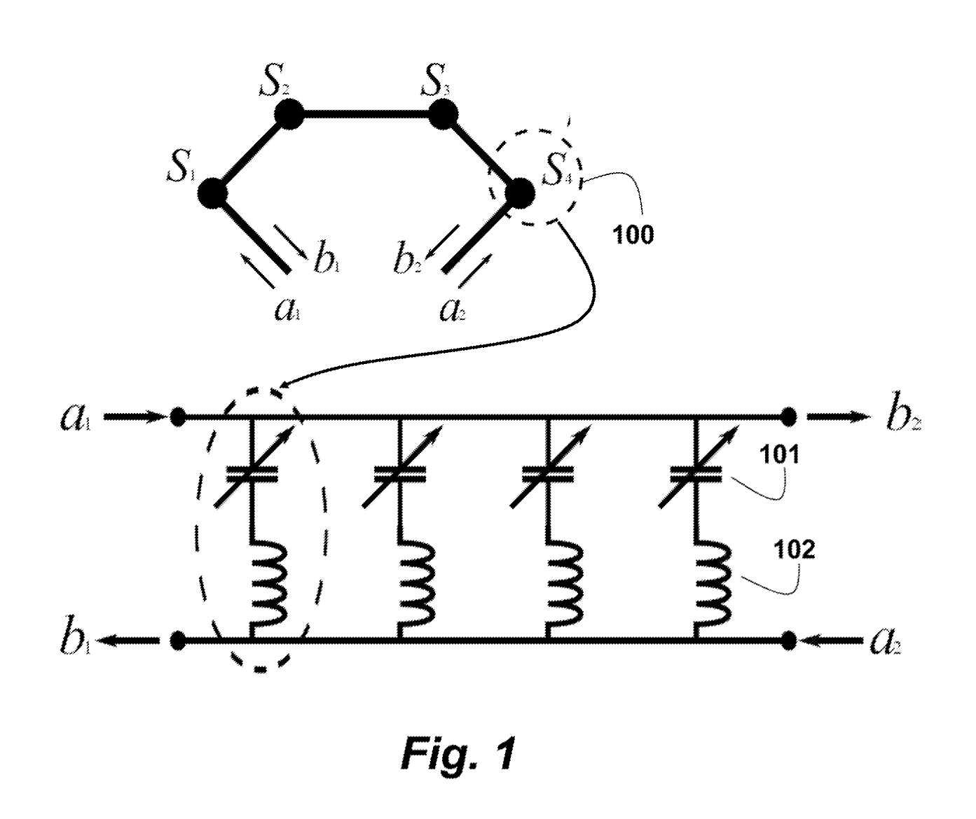

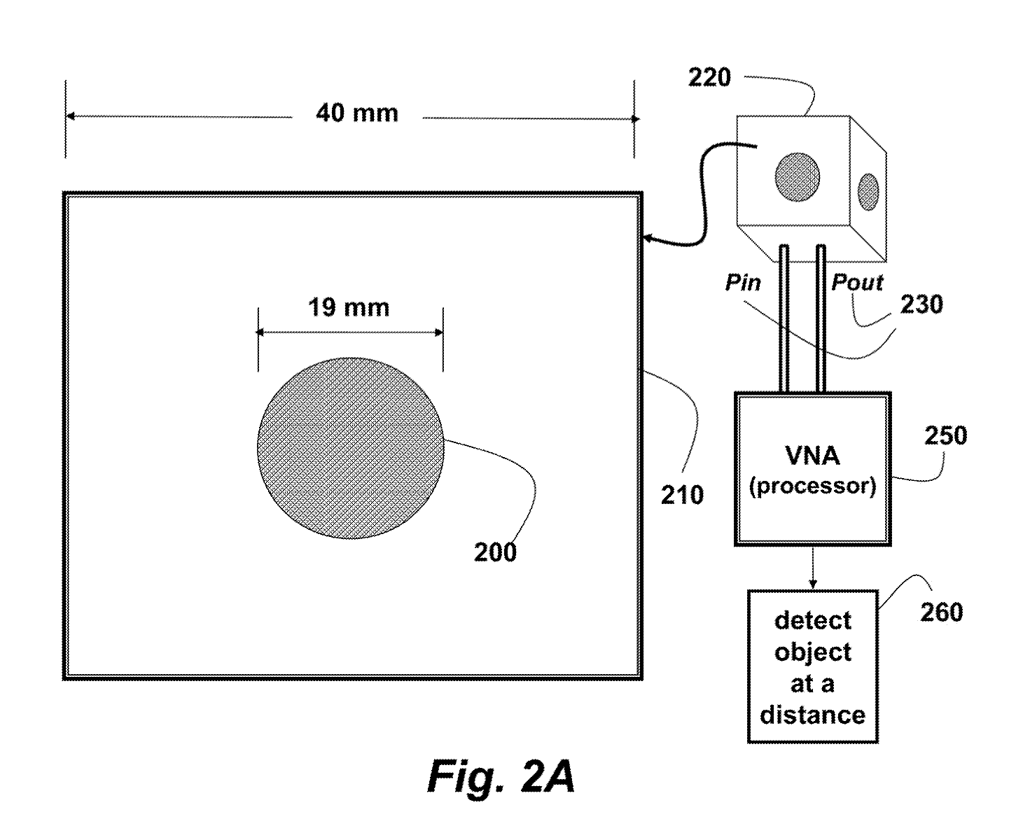

FIGS. 1 and 2A show an exemplar sensor. The sensor uses a set of two or more sensing elements 100, e.g., four. The elements can be connected in parallel, series or cascaded. In one embodiment, the sensing elements are oriented in different directions. For example, the sensing elements are arranged on four side faces 210 of a cube 220. Two ports (Pin and Pout) 230 are provided, to read the sensor.

In the embodiment shown in FIG. 2A, the sensing element is a circular metal disk with ground plane behind it. However, the sensing element could be any shape, not limited to what is shown in FIG. 2A.

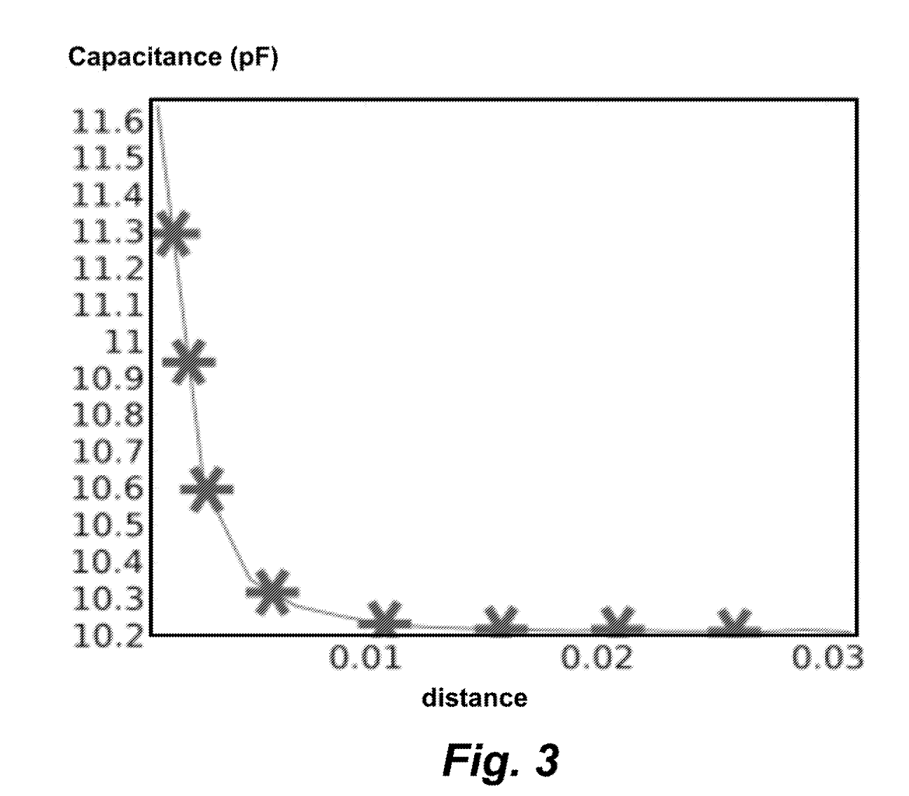

The sensing elements of the sensor can be read by some form of a vector network analyzer (VNA) 250, which can be implemented, for example, in a processor connected to memory, the input/output interfaces 230 as known in the art. For example, the processor measures a change in transmission around the notch frequency to detect the object and to measure the capacitance, which is a function of distances 260 as shown in FIG. 4.

In the embodiment shown in FIG. 1, the sensor is integrated into a four-element array with a bandstop filter, and an equivalent circuit. Each node (S₁, S₂, S₃, S₄) 100 represents a sensor element, which has a variable capacitance 101 in series with an inductor 102 to form a resonance. Each sensor element corresponds to one series LC tank. The input and output signals are indicated by a and b. The directions (a1, b1, a2, b2) are typically used in a two-port microwave device. For such device, incident wave can be at port 1 or port 2, and a1 is wave incident at port 1, b1 is reflected at port 1, and b2 is transmitted to port 2. If wave is incident at port 2 (a2), then b2 is reflected at port 2, b1 is transmitted to port 1.

The capacitance values relate to central frequencies of the handstops. As an advantage, the capacitance measurement can be shifted to measuring the bandstop, or other related quantities, which enables frequency domain measurement, and the resonant frequency can be controlled by the series inductance. A small perturbation is determined by the variation of the capacitance to freely set a different resonant frequency to the resonator independent, of the capacitance.

The capacitive sensor array can be measured in the frequency domain by biasing all the sensing elements at different resonant frequencies, which are substantially decoupled. Complete decoupling is not feasible. Then, all the capacitance values are represented in the frequency response of the bandstop filter, i.e. each capacitance corresponds to a bandstop frequency.

As shown in FIG. 2A for one embodiment, the capacitor array is implemented as a circular conductive patch 200 on each of four sides 210 of a cubic substrate structure 220. The patch has a diameter of 9 mm and is arranged on a FR4 glass epoxy substrate (permittivity ε=4.5) measuring, e.g., 40×40 mm in area, and 1.2 mm thick. The bottom side of the substrate has a copper ground plane. A coaxial connector is placed as the center for excitation. The conductive patch in series with an inductor, and the patch and the ground plane form a capacitor, and the inductor and the capacitor form an LC resonant circuit.

FIG. 2B shows alternative geometries for the arrangement of the sensors, in either 2D or 3D directions. A common feature of the sensors according to the embodiments is the isolation of resonances from each element so that the elements do not interact with each other.

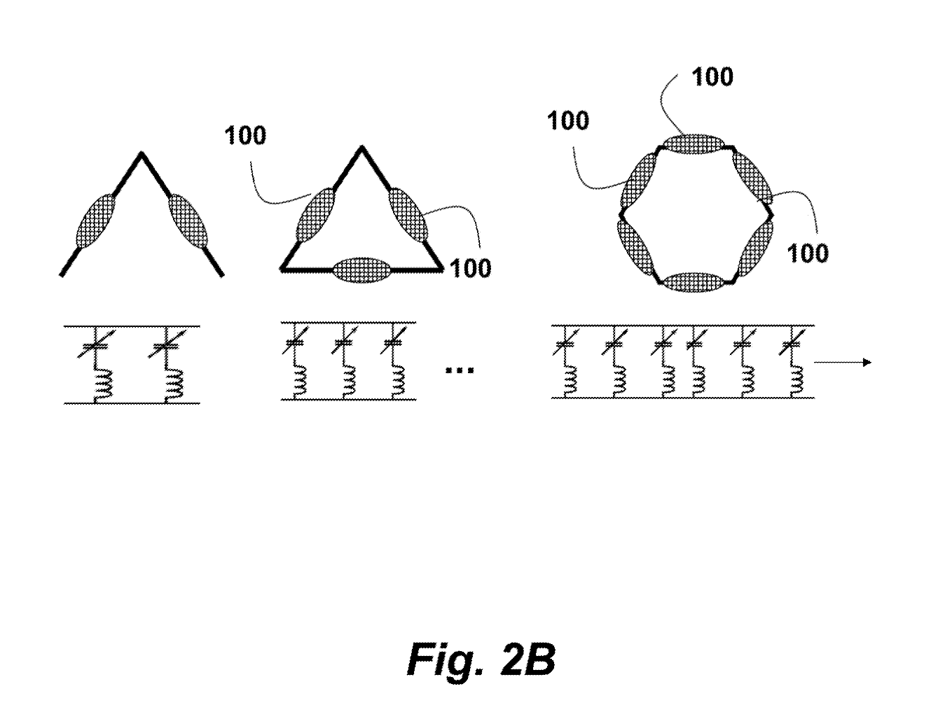

FIG. 3 shows an example capacitance change as a function of a distance (0.0-0.03 m) from an object, e.g., from 10.2 pF to 11.6 pF.

FIG. 4 shows how the capacitor is integrated into a bandstop filter for a circuit simulation, where four ideal capacitors have the same nominal value of 10.2 pF. To relate each capacitor to different resonance separately, the four bandstop are sufficiently separated.

In the design, the bandstops are controlled by manipulating the product of LC, as it directly determines the bandstop frequency, where L and C are the capacitance and inductance in nH and pF, respectively. The four LC products are selected as 800, 600, 300, 100, and the inductance values are selected as 82 nH, 56 nH, 27 nH, 8.2 nH, respectively. Thus, the corresponding resonant frequencies are 174 MHz, 211 MHz, 303 MHz. and 550 MHz, respectively.

To simplify the design, all sensing elements are with the same dimensions as shown in FIG. 2, and all the capacitors and inductors are ideal components with infinite Q in the simulation. Besides the aforementioned capacitors and inductors, the effect has been taken into account in the circuit simulation. There are two types of TLine, MLIN1 and MLIN2. MLIN1 is for the feeding network, and MLIN2 is for connecting each of the LC tanks. They are all 50 ΩTLines, and their lengths are determined according to the final fabrication. In the simulation, the four capacitors are swept from 10.2 pF to 11.6 pF, respectively, as for emulating each capacitive change.

During simulation four decoupled bandstops are detected. Their values are consistent with the calculated resonant frequency described above, which shows an independent control of the resonant frequency. With the variation of each capacitance, the corresponding notch frequencies change, with all other notches unaffected. It should be noticed that the resonant frequencies deviate from what was calculated. This is because of the TLine effect, especially the MLIN2 shown in FIG. 3. However, despite of the shifting of the resonant frequencies, this does not. affect the separation of the resonant frequencies. Therefore, the capacitive sensing elements are substantially decoupled from each other, and each of is represented by one notch frequency to show frequency-domain multiplexing.

Fabrication and Measurement

Each sensing, element is arranged on a 3-layer printed circuit board (PCB), with the epoxy substrate, The top layer is the circular patch, connected to a 50 Ω TLine on the bottom layer through a via. The middle layer is a ground plane, which is 1.2 mm below the top layer and 0.3 mm above the bottom layer. The feeding network is a folded TLine designed on a 1.5 mm thick 2-layer PCB (FR4 substrate). A folded shape is used because the sensor is designed to detecting in different directions. The four capacitive sensor elements are arranged as the cube 220 in FIG. 2 The feeding network is connected to the four sensing elements from one side. All the ground planes are soldered together.

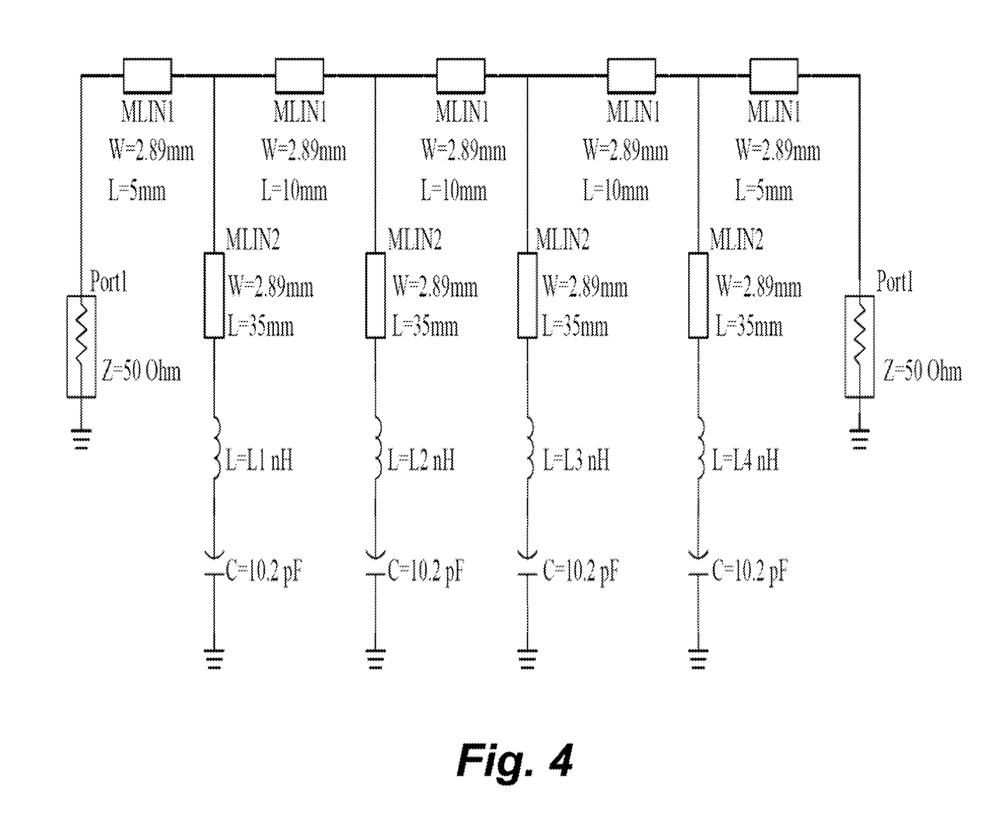

FIG. 5 shows is multiple elements 100 arranged along a coaxial connector between an input port (Pin) and output port (Pout) according to embodiments of the invention;

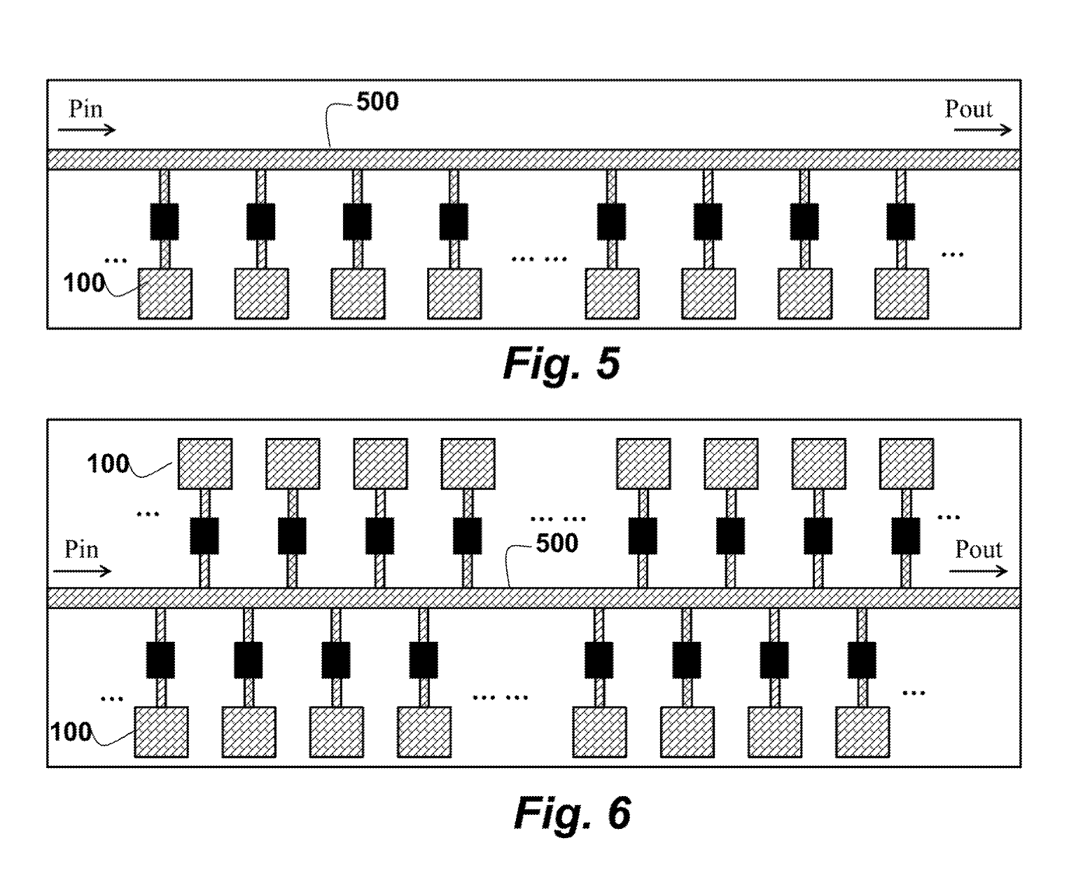

FIG. 6 is a schematic of a sensor with multiple elements arranged along either side of a coaxial connector between an input port (Pin) and output port (Pout) according to embodiments of the invention;

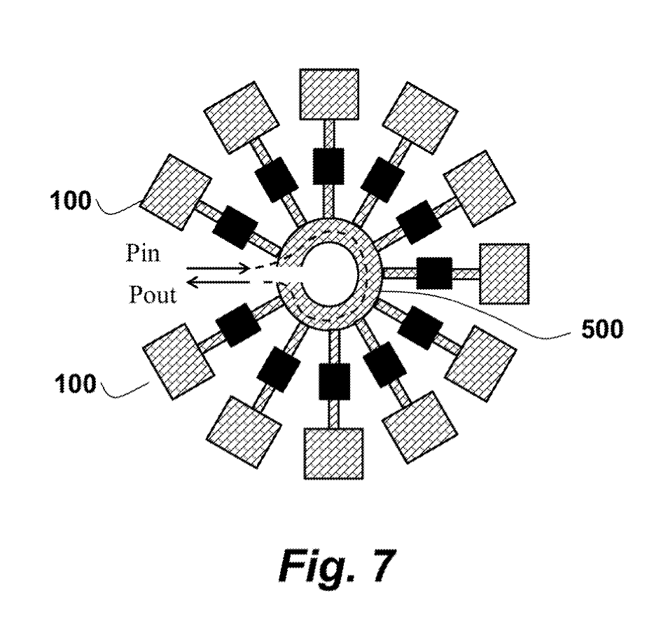

FIG. 7 is a schematic of a sensor with multiple elements arranged serially circular a coaxial connector between an input port (Pin) and output port (Pout).

### Effect of Invention

The embodiments of the invention provide a capacitive proximity sensor array based on a bandstop filter design. A multi-element capacitive proximity sensor array is integrated into a multi-band bandstop filter by a series of capacitive sensor elements and an inductor. The four bandstops are substantially decoupled and isolated from each other by selecting different inductance values. Complete decoupling and isolation are not feasible. Measurement results show an ability of distinguishing in four directions with a sensing range about 8 mm. This frequency-domain multi-directional capacitive proximity sensor array can be extended to other capacitive sensing arrays. The frequency domain readout technique can use time division multiplexing for a faster readout response.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A proximity sensor for detecting an object, comprising:
a set of two or more sensing elements, wherein each sensing element includes a bandstop filter for selecting a different notch resonant frequency for the element, wherein the notch resonant frequencies are substantially isolated from each other; and
means for measuring a change in transmission around each notch frequency to detect the object, wherein the means for measuring is implemented in a processor.

2. The proximity sensor of claim 1, wherein the elements are oriented in different directions.

3. The proximity sensor of claim 1, wherein a sensing range is about 8 mm.

4. The proximity sensor of claim 1, wherein the bandstop filter includes a capacitive sensing element connected in series with an inductor.

5. The proximity sensor of claim 1, wherein each bandstop filter includes a series parallel-resonance tank and shunt series-resonance tank to form a bandstop response.

6. The proximity sensor of claim 1, wherein each bandstop filter is biased at a different resonant frequency, and the resonant frequencies are substantially decoupled.

7. The proximity sensor of claim 1, wherein the sensor includes a conductive patch in series with an inductor, and the patch and the ground plane form a capacitor, and the inductor and the capacitor form an LC resonant circuit.

8. The proximity sensor of claim 1, wherein the elements are arranged in a plane.

9. The proximity sensor of claim 1, wherein the processor measures a change in capacitance.

10. The proximity sensor of claim 9, wherein the change in capacitance is function of a distance to the object.

11 The proximity sensor of claim 1, wherein the elements are connected in parallel.

12. The proximity sensor of claim 1, wherein the elements are connected in series.

13. proximity sensor of claim 1, wherein the elements are cascaded parallel.

14. A method for detecting an object with a proximity sensor, comprising:
selecting a different notch resonant frequency for a set of two or more sensing elements, wherein each sensing element includes a bandstop filter for selecting the different notch resonant frequencies, wherein the notch resonant frequencies are isolated from each other measuring a change in transmission around each notch frequency to detect to the object, wherein measuring is implemented in a processor.

15. The method of claim 14, further comprising:
measuring a change in capacitance for each element.

16. The method of claim 14, wherein the change in capacitance is a function of a distance to the object.
